(19) United States
(12) Patent Application Publication
(10) Pub. No.: US 2024/0143284 A1
(43) Pub. Date: May 2, 2024

(54) DATA PROCESSING APPARATUS AND PROGRAM

(71) Applicant: Murata Manufacturing Co., Ltd., Kyoto (JP)

(72) Inventors: Jun MAKINO, Kyoto (JP); Koji KAWANO, Kyoto (JP); Nobuyuki NOZAWA, Kyoto (JP); Tomoshige FURUHI, Kyoto (JP); Takashi WATANABE, Kyoto (JP); Takehiko IIZUKA, Kyoto (JP); Kenta AGO, Kyoto (JP)

(21) Appl. No.: 18/410,167

(22) Filed: Jan. 11, 2024

Related U.S. Application Data
(63) Continuation of application No. PCT/JP2022/023398, filed on Jun. 10, 2022.

(30) Foreign Application Priority Data
Jul. 15, 2021 (JP) 2021-116951

(51) Int. Cl. G06F 7/76

(52) U.S. Cl. CPC G06F 7/76

(57) ABSTRACT

A data processing apparatus includes an arithmetic circuit that performs an acquiring step of acquiring swing data indicating relationship between a physical quantity concerning an amount of deformation of an object to be measured and time, a determining step of determining whether the swing data indicates the physical quantity concerning the amount of deformation of the object to be measured, which occurs when the object to be measured is swung, to determine whether the swing data is to be deleted, and a deleting step of deleting the swing data if it is determined that the swing data does not indicate the physical quantity concerning the amount of deformation of the object to be measured, which occurs when the object to be measured is swung.

### CROSS REFERENCE TO RELATED APPLICATION

This is a continuation of International Application No. PCT/JP2022/023398 filed on Jun. 10, 2022 which claims priority from Japanese Patent Application No. 2021-116951 filed on Jul. 15, 2021. The contents of these applications are incorporated herein by reference in their entireties.

### BACKGROUND OF THE DISCLOSURE

### Field of the Disclosure

The present disclosure relates to a data processing apparatus determining whether data is to be deleted.

### Description of the Related Art

A swing analysis apparatus described in Patent Document 1 has hitherto been known as a disclosure to analyze the swing of a golf club by a user. In the swing analysis apparatus described in Patent Document 1, a sensor is mounted to the shaft of the golf club. The swing analysis apparatus analyzes the swing of the user based on a signal acquired from the sensor.
Patent Document 1: Japanese Unexamined Patent Application Publication No. 2018-175496

### BRIEF SUMMARY OF THE DISCLOSURE

In the field of the swing analysis apparatus described in Patent Document 1, it is desirably difficult to squeeze the capacity of a storage medium that stores data used for analyzing the swing of the user.

It is a possible benefit of the present disclosure to provide a data processing apparatus with which the capacity of a storage medium is less likely to be squeezed.

A data processing apparatus according to an aspect of the present disclosure includes an arithmetic circuit that performs an acquiring step of acquiring swing data indicating relationship between a physical quantity concerning an amount of deformation of an object to be measured and time, a determining step of determining whether the swing data indicates the physical quantity concerning the amount of deformation of the object to be measured, which occurs when the object to be measured is swung, to determine whether the swing data is to be deleted, and a deleting step of deleting the swing data if it is determined that the swing data does not indicate the physical quantity concerning the amount of deformation of the object to be measured, which occurs when the object to be measured is swung.

In this description, axes and members extending in the front-back direction do not necessarily represent axes and members parallel to the front-back direction. The axes and members extending in the front-back direction represent axes and members tilting in a range of ±45 degrees with respect to the front-back direction. Similarly, axes and members extending in the vertical direction represent axes and members tiling in a range of ±45 degrees with respect to the vertical direction. Axes and members extending in the left-right direction represent axes and members tilting in a range of ±45 degrees with respect to the left-right direction.

In this description, arrangement of a first member on a second member represents the following state. At least part of the first member is positioned immediately above the second member. Accordingly, when viewed in the vertical direction, the first member is overlapped with the second member. This definition applies to the directions other than the vertical direction.

In this description, arrangement of the first member above the second member includes a case in which at least part of the first member is positioned immediately above the second member and a case in which the first member is not positioned immediately above the second member but is positioned obliquely above the second member. In this case, when viewed in the vertical direction, the first member is not necessarily overlapped with the second member. Obliquely above means, for example, upper left and upper right. This definition applies to the directions other than the vertical direction.

In this description, the respective portions of the first member are defined in the following manner unless otherwise specified. The front portion of the first member means the front half of the first member. The back portion of the first member means the back half of the first member. The left portion of the first member means the left half of the first member. The right portion of the first member means the right half of the first member. The upper portion of the first member means the upper half of the first member. The lower portion of the first member means the lower half of the first member. The front end of the first member means the end in the front direction of the first member. The back end of the first member means the end in the back direction of the first member. The left end of the first member means the end in the left direction of the first member. The right end of the first member means the end in the right direction of the first member. The upper end of the first member means the end in the upper direction of the first member. The lower end of the first member means the end in the lower direction of the first member. The front end portion of the first member means the front end and the neighborhood of the front end of the first member. The back end portion of the first member means the back end and the neighborhood of the back end of the first member. The left end portion of the first member means the left end and the neighborhood of the left end of the first member. The right end portion of the first member means the right end and the neighborhood of the right end of the first member. The upper end portion of the first member means the upper end and the neighborhood of the upper end of the first member. The lower end portion of the first member means the lower end and the neighborhood of the lower end of the first member.

With the data processing apparatus according to present disclosure, the capacity of a storage medium is less likely to be squeezed.

### BRIEF DESCRIPTION OF THE SEVERAL VIEWS OF THE DRAWINGS

FIG. 1 is a diagram illustrating one example of an object-to-be-measured 1 on which a data processing apparatus 2 is mounted.

FIG. 2 is a block diagram illustrating one example of the configuration of the data processing apparatus 2.

FIG. 3 includes a rear view and a left-side view of a sensor 10.

FIG. 4 is a graph indicating one example of swing data SwD.

FIG. 5 is a flowchart indicating a process performed by the data processing apparatus 2.

FIG. 6 is a graph indicating swing data SwDN that is acquired when the object-to-be-measured 1 is deformed in response to an operation other than swing.

FIG. 7 is a block diagram illustrating one example of the configuration of a data processing apparatus 2a.

FIG. 8 is a flowchart indicating a process performed by the data processing apparatus 2a.

FIG. 9 is a block diagram illustrating one example of the configuration of a data processing apparatus 2b.

FIG. 10 is a flowchart indicating a process performed by the data processing apparatus 2b.

FIG. 11 is a graph indicating a first modification of a determination method in a determining step.

FIG. 12 is a graph indicating a second modification of the determination method in the determining step.

### DETAILED DESCRIPTION OF THE DISCLOSURE

### First Embodiment

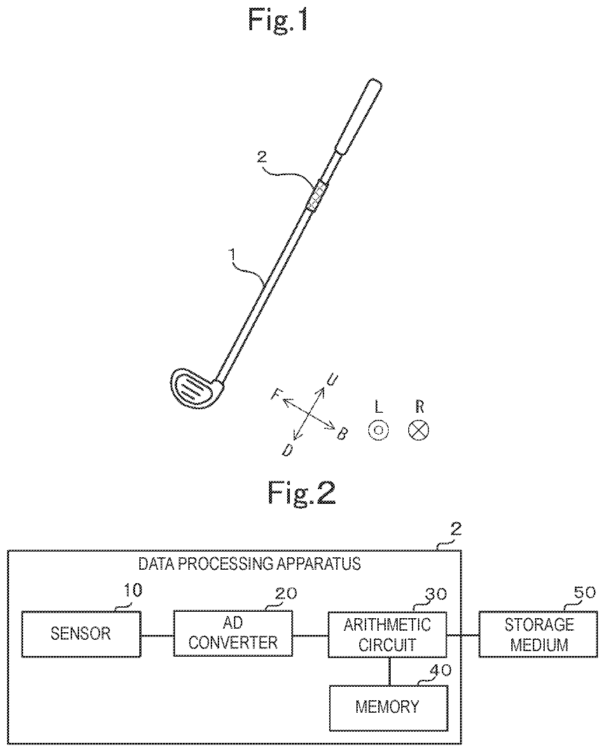

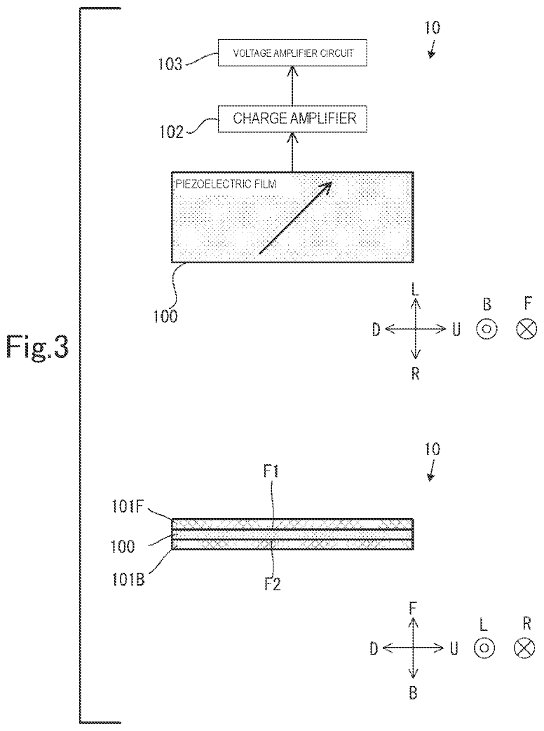

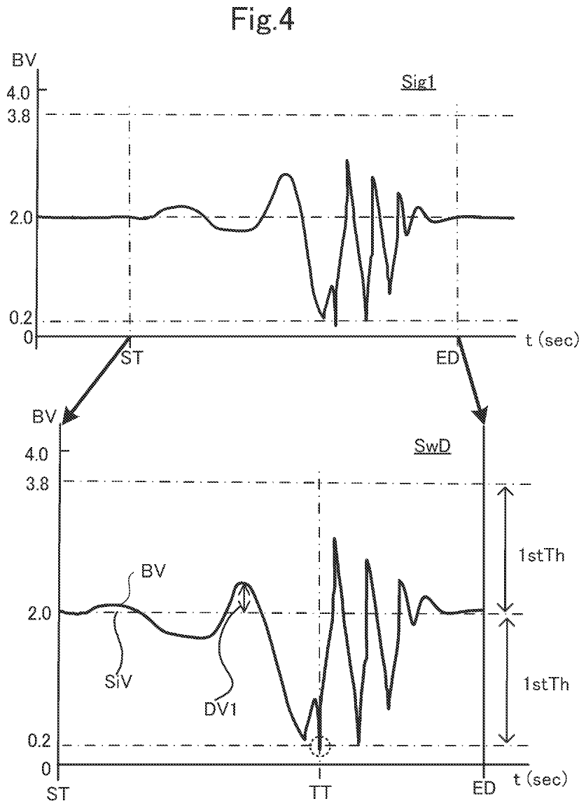

A data processing apparatus 2 according to a first embodiment will herein be described with reference to the drawings. FIG. 1 is a diagram illustrating one example of an object-to-be-measured 1 on which the data processing apparatus 2 is mounted. FIG. 2 is a block diagram illustrating one example of the configuration of the data processing apparatus 2. FIG. 3 includes a rear view and a left-side view of a sensor 10. Illustration of a first electrode 101F and a second electrode 101B is omitted in the rear view illustrated in FIG. 3. FIG. 4 is a graph indicating one example of swing data SwD. Referring to FIG. 4, the vertical axis represents output of a signal. Referring to FIG. 4, the horizontal axis represents time.

In the present embodiment, the vertical direction, the left-right direction, and the front-back direction are defined in a manner illustrated in FIG. 1. Specifically, the direction in which the shaft of the object-to-be-measured 1 extends is defined as the vertical direction. The direction to which the face of the head of the object-to-be-measured 1 is directed is defined as the left direction. The direction orthogonal to the vertical direction and the left-right direction is defined as the front-back direction. However, the vertical direction, the left-right direction, and the front-back direction are the directions defined for description. Accordingly, the vertical direction, the left-right direction, and the front-back direction in practical use of the object-to-be-measured 1 do not necessarily coincide with the vertical direction, the left-right direction, and the front-back direction illustrated in FIG. 1.

In the present embodiment, the object-to-be-measured 1 is a golf club. Accordingly, as illustrated in FIG. 1, the object-to-be-measured 1 has a rod shape extending in the vertical direction. A user swings the object-to-be-measured 1. The object-to-be-measured 1 is deformed in response to the swing by the user. Specifically, the object-to-be-measured 1 is deformed due to force of inertia or external force when the user swings the object-to-be-measured 1. The object-to-be-measured 1 is deformed, for example, in the left-right direction in response to the swing.

As illustrated in FIG. 1, the data processing apparatus 2 is mounted on the object-to-be-measured 1. In the present embodiment, the data processing apparatus 2 includes the sensor 10, an analog-to-digital (AD) converter 20, an arithmetic circuit 30, and a memory 40, as illustrated in FIG. 2. The sensor 10, the AD converter 20, the arithmetic circuit 30, and the memory 40 are mounted on the object-to-be-measured 1. More accurately, the sensor 10, the AD converter 20, the arithmetic circuit 30, and the memory 40 are fixed to the object-to-be-measured 1.

The sensor 10 detects the physical quantity concerning the amount of deformation of the object-to-be-measured 1. The physical quantity concerning the amount of deformation of the object-to-be-measured 1 is a numerical value that is varied in response to variation in the amount of deformation of the object-to-be-measured 1. The physical quantity concerning the amount of deformation of the object-to-be-measured 1 is, for example, the amount of deformation of the object-to-be-measured 1, the differential value of the amount of deformation of the object-to-be-measured 1, or the stress occurring at the object-to-be-measured 1. In the present embodiment, the physical quantity concerning the amount of deformation of the object-to-be-measured 1 is the differential value of the amount of deformation of the object-to-be-measured 1. The differential value of the amount of deformation of the object-to-be-measured 1 is hereinafter referred to as a differential value BV. The sensor 10 generates electric charge corresponding to the physical quantity concerning the amount of deformation of the object-to-be-measured 1. In the present embodiment, the sensor 10 generates the electric charge corresponding to the differential value BV. In addition, the sensor 10 converts the electric charge into an output signal Sig1, which is a voltage signal. The sensor 10 continuously acquires the output signal Sig1 at a sampling interval of the sensor 10. The value of the output signal Sig1 is a value corresponding to the differential value of the amount of deformation in the left-right direction of the object-to-be-measured 1. The object-to-be-measured 1 is elastically deformed.

Accordingly, the differential value of the amount of deformation in the left-right direction of the object-to-be-measured 1 is proportional to force applied to the object-to-be-measured 1 when the user swings the object-to-be-measured 1. In other words, the value of the output signal Sig1 indirectly indicates the force that is applied when the user swings the object-to-be-measured 1.

The structure of the sensor 10 will now be described. The sensor 10 is a piezoelectric sensor that detects pressure. The sensor 10 includes a piezoelectric film 100, the first electrode 101F, the second electrode 101B, a charge amplifier 102, and a voltage amplifier circuit 103, as illustrated in FIG. 3. The piezoelectric film 100 is sheet-shaped. Accordingly, the piezoelectric film 100 has a first main surface F1 and a second main surface F2, as illustrated in FIG. 3. The length in the vertical direction of the piezoelectric film 100 is longer than the length in the left-right direction of the piezoelectric film 100. In the present embodiment, the piezoelectric film 100 has a rectangular shape having long sides extending in the vertical direction when viewed in the front-back direction. The piezoelectric film 100 generates the electric charge corresponding to the differential value BV of the amount of deformation of the piezoelectric film 100. In the present embodiment, the piezoelectric film 100 is a PLA film. The piezoelectric film 100 will be described in more detail below.

The piezoelectric film 100 has a characteristic in which the polarity of the electric charge occurring when the piezoelectric film 100 is deformed so as to be extended in the vertical direction is opposite to the polarity of the electric charge occurring when the piezoelectric film 100 is deformed so as to be extended in the left-right direction. Specifically, the piezoelectric film 100 is a film made of chiral polymer. The chiral polymer is, for example, polylactic acid (PLA), particularly, poly-L-lactic acid (PLLA). The main chain of PLLA made of chiral polymer has a helical structure. PLLA has piezoelectricity in which the film is uniaxially stretched to orient molecules. The piezoelectric film 100 has a piezoelectric constant of d14. The uniaxial stretching direction (the orientation direction) of the piezoelectric film 100 makes an angle of 45 degrees with respect to each of the vertical direction and the left-right direction. The angle of 45 degrees includes, for example, angles of 45 degrees±about 10 degrees. Accordingly, the piezoelectric film 100 generates the electric charge due to the deformation of the piezoelectric film 100 so as to be extended in the vertical direction or the deformation of the piezoelectric film 100 so as to be compressed in the vertical direction. The piezoelectric film 100 generates the positive electric charge, for example, when the piezoelectric film 100 is deformed so as to be extended in the vertical direction. The piezoelectric film 100 generates the negative electric charge, for example, when the piezoelectric film 100 is deformed so as to be compressed in the vertical direction. The magnitude of the electric charge depends on the differential value BV of the amount of deformation in the vertical direction of the piezoelectric film 100 due to the extension or the compression.

The first electrode 101F is a signal electrode. The first electrode 101F is provided on the first main surface F1. The first main surface F1 is covered with the first electrode 101F. The first electrode 101F is, for example, an organic electrode made of indium tin oxide (ITO), zinc oxide (ZnO), or the like, a metal film formed by vapor deposition or plating, or a printed electrode film formed with silver paste.

The second electrode 101B is a ground electrode. The second electrode 101B is connected to ground potential. The second electrode 101B is provided on the second main surface F2. Accordingly, the piezoelectric film 100 is positioned between the first electrode 101F and the second electrode 101B. The second main surface F2 is covered with the second electrode 101B. The second electrode 101B is, for example, an organic electrode made of indium tin oxide (ITO), zinc oxide (ZnO), or the like, a metal film formed by vapor deposition or plating, or a printed electrode film formed with silver paste.

The sensor 10 having the above structure is fixed to the object-to-be-measured 1 via a bonding layer (not illustrated). Specifically, the object-to-be-measured 1 is fixed to the first electrode 101F with the bonding layer. With this structure, for example, when the object-to-be-measured 1 is bent in the left-right direction, the object-to-be-measured 1 is extended or compressed in the vertical direction. Accordingly, the piezoelectric film 100 is extended or compressed in the vertical direction. As a result, the piezoelectric film 100 generates the electric charge. In other words, in the present embodiment, when the object-to-be-measured 1 is bent in the right direction, the piezoelectric film 100 generates the negative electric charge. In the present embodiment, when the object-to-be-measured 1 is bent in the left direction, the piezoelectric film 100 generates the positive electric charge.

The charge amplifier 102 converts the electric charge generated by the piezoelectric film 100 into the output signal Sig1, which is the voltage signal. After the conversion, the charge amplifier 102 supplies the output signal Sig1 to the voltage amplifier circuit 103. The voltage amplifier circuit 103 amplifies the output signal Sig1 and supplies the amplified output signal Sig1 to the AD converter 20.

The AD converter 20 performs analog-to-digital (AD) conversion of the output signal Sig1 to convert the output signal Sig1 into a digital signal.

The arithmetic circuit 30 performs an acquiring step of acquiring the swing data SwD, a determining step of determining whether the swing data SwD is to be deleted, and a deleting step of deleting the swing data SwD if it is determined that the swing data SwD is to be deleted. The swing data SwD indicates the relationship between the physical quantity concerning the amount of deformation of the object-to-be-measured 1 and time. In the present embodiment, the swing data SwD indicates the relationship between the differential value BV of the amount of deformation of the object-to-be-measured 1 and a time t, as illustrated in FIG. 4. More accurately, the swing data SwD indicates the relationship between the differential value BV of the amount of deformation in the left-right direction of the object-to-be-measured 1 and the time t. In this case, the swing data SwD includes a numerical value corresponding to the physical quantity concerning the amount of deformation of the object-to-be-measured 1. The arithmetic circuit 30 generates the swing data SwD based on the output signal Sig1. More specifically, the arithmetic circuit 30 converts part of the output signal Sig1 outputted from the sensor 10 into the swing data SwD. For example, as illustrated in FIG. 4, the sensor 10 continuously outputs the output signal Sig1. At this time, the arithmetic circuit 30 converts a portion of the output signal Sig1, which is outputted from a time ST to a time ED, into the swing data SwD. The time ED is a time after the time ST. Accordingly, the arithmetic circuit 30 generates the swing data SwD indicating the relationship between the differential value BV from the time ST to the time ED and the time t. In other words, in the present embodiment, the arithmetic circuit 30 generates the swing data SwD based on the output signal Sig1 to acquire the swing data SwD. After generating the swing data SwD, the arithmetic circuit 30 performs the determining step.

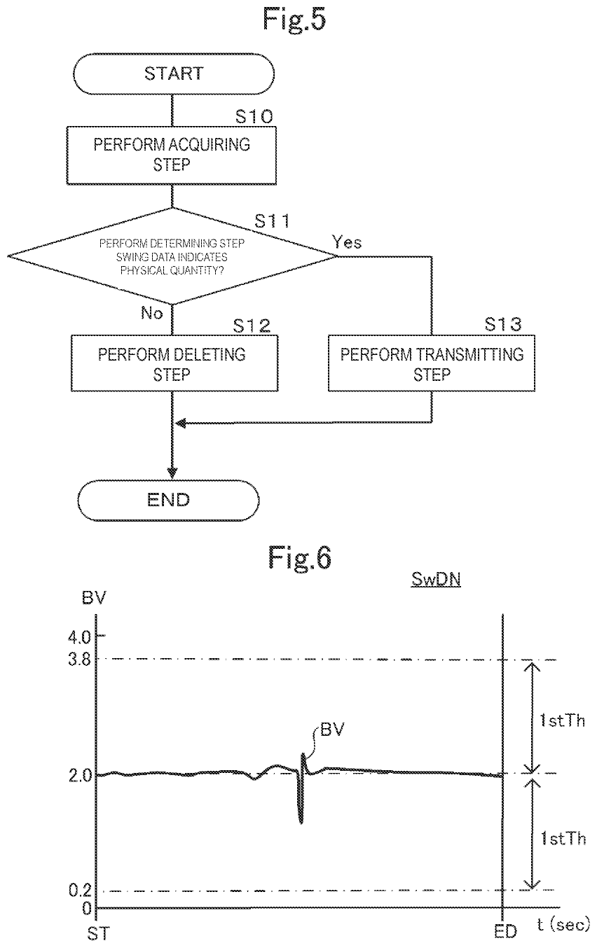

The acquiring step, the determining step, and the deleting step, which are performed by the arithmetic circuit 30, will now be described in detail with reference to FIG. 4, FIG. 5, and FIG. 6. FIG. 5 is a flowchart indicating a process performed by the data processing apparatus 2. FIG. 6 is a graph indicating swing data SwDN that is acquired when the object-to-be-measured 1 is deformed in response to an operation other than the swing. Specifically, referring to FIG. 6, the swing data SwDN indicates the deformation of the object-to-be-measured 1 when the user pushes down the object-to-be-measured 1. Referring to FIG. 6, the vertical axis represents output of the signal. Referring to FIG. 6, the horizontal axis represent time.

The process in the arithmetic circuit 30 is started in response to turning on of the data processing apparatus 2 (START in FIG. 5). After the process is started, the arithmetic circuit 30 performs the acquiring step of acquiring the swing data SwD (refer to the graph at the bottom of FIG. 4) indicating the relationship between the differential value BV (the physical quantity concerning the amount of deformation of the object-to-be-measured 1) and the time t (Step S10 in FIG. 5). Since the acquiring step is described above in detail, a further description of the acquiring step is omitted herein.

Next, the arithmetic circuit 30 performs the determining step of determining whether the swing data SwD indicates the differential value BV (the physical quantity concerning the amount of deformation of the object-to-be-measured 1), which occurs when the object-to-be-measured 1 is swung, to determine whether the swing data SwD is to be deleted (Step S11 in FIG. 5). When the user swings the object-to-be-measured 1, the object-to-be-measured 1 is greatly deformed. In this case, the object-to-be-measured 1 has a large amount of deformation. Accordingly, the differential value BV has a high value. In contrast, when the user deforms the object-to-be-measured 1 with an operation other than the swing, the object-to-be-measured 1 is not greatly deformed. In this case, the object-to-be-measured 1 has a small amount of deformation. Accordingly, the differential value BV has a low value. As described above, the arithmetic circuit 30 is capable of determining whether the swing data SwD indicates the differential value BV occurring when the object-to-be-measured 1 is swung by calculating the magnitude of the differential value BV.

In the case of the method described above, the data processing apparatus 2 is capable of determining whether the swing data SwD indicates the differential value BV occurring when the object-to-be-measured 1 is swung, for example, by using a first determination value 1stTh. Specifically, the data processing apparatus 2 stores the first determination value 1stTh. For example, as illustrated in FIG. 4, the data processing apparatus 2 stores the first determination value 1stTh=1.8. Next, the arithmetic circuit 30 calculates the absolute value of the difference between a reference value Siv and the differential value BV (the numerical value corresponding to the physical quantity). Here, the absolute value of the difference between the reference value Siv and the differential value BV is defined as a first difference value DV1. The arithmetic circuit 30 determines whether the maximum value of the first difference value DV1 in the swing data SwD is higher than or equal to the first determination value 1stTh. In the example illustrated in FIG. 4, the first difference value DV1 has the maximum value at a time TT. Accordingly, the arithmetic circuit 30 determines whether the value of the first difference value DV1 at the time TT is higher than or equal to the first determination value 1stTh. Specifically, the differential value BV has a value of “0.2” at the time TT. The reference value Siv has a value of “2.0”. In this case, the value resulting from subtraction of reference value Siv from the differential value BV is “−1.8”. Accordingly, the arithmetic circuit 30 calculates the first difference value DV1 as “1.8”.

After calculating the first difference value DV1, the arithmetic circuit 30 determines whether the first difference value DV1 is higher than or equal to the first determination value 1stTh. If the first difference value DV1 is higher than or equal to the first determination value 1stTh, the arithmetic circuit 30 determines that the swing data SwD is not to be deleted. In the example illustrated in FIG. 4, at the time TT, the first difference value DV1 has a value of “1.8” and the first determination value 1stTh has a value of “1.8”. In this case, the first difference value DV1 is higher than or equal to the first determination value 1stTh. Accordingly, the arithmetic circuit 30 determines that the deletion of the swing data SwD is not necessary.

In contrast, if the first difference value DV1 is lower than the first determination value 1stTh, the arithmetic circuit 30 determines that the swing data SwD is to be deleted. For example, in the swing data SwDN illustrated in FIG. 6, the differential value BV is lower than the first determination value 1stTh. Accordingly, the arithmetic circuit 30 determines that the deletion of the swing data SwDN illustrated in FIG. 6 is necessary.

If the arithmetic circuit 30 determines that the deletion of the swing data SwD is necessary, the arithmetic circuit 30 performs the deleting step of deleting the swing data SwD. In other words, if the arithmetic circuit 30 determines that the swing data SwD does not indicate the differential value BV occurring when the object-to-be-measured 1 is swung in the determining step (No in Step S11 in FIG. 5), the arithmetic circuit 30 performs the deleting step of deleting the swing data SwD (Step S12 in FIG. 5).

If the arithmetic circuit 30 determines that the deletion of the swing data SwD is not necessary, the arithmetic circuit 30 performs a transmitting step of transmitting the swing data SwD to the storage medium 50. In other words, if the arithmetic circuit 30 determines that the swing data SwD indicates the differential value BV occurring when the object-to-be-measured 1 is swung in the determining step (Yes in Step S11 in FIG. 5), the arithmetic circuit 30 performs the transmitting step of transmitting the swing data SwD to the storage medium 50 (Step S13 in FIG. 5). Specifically, as illustrated in FIG. 2, the arithmetic circuit 30 is connected to the storage medium 50 so as to be capable of communication. The arithmetic circuit 30 transmits the swing data SwD to the storage medium 50. In this case, a server (not illustrated) or the like includes the storage medium 50.

The process described above is performed by the arithmetic circuit 30 that reads out a program concerning the process in the arithmetic circuit 30 from the memory 40. Specifically, as illustrated in FIG. 2, the arithmetic circuit 30 is connected to the memory 40 so as to be capable of communication. The memory 40 stores the program concerning the process including the acquiring step, the determining step, and the deleting step. The memory 40 includes, for example, a read only memory (ROM) and a random access memory (RAM). The arithmetic circuit 30 reads out the program stored in the ROM into the RAM. Then, the arithmetic circuit 30 performs the acquiring step, the determining step, and the deleting step. The arithmetic circuit 30 described above is, for example, a central processing unit (CPU).

### Effects of First Embodiment

With the data processing apparatus 2, the capacity of the storage medium 50 is less likely to be squeezed. More specifically, the data processing apparatus 2 includes the arithmetic circuit 30. The arithmetic circuit 30 performs the acquiring step, the determining step, and the deleting step. In the acquiring step, the arithmetic circuit 30 acquires the swing data SwD indicating the relationship between the differential value BV (the physical quantity concerning the amount of deformation of the object-to-be-measured 1) and the time t. In the determining step, the arithmetic circuit 30 determines whether the swing data SwD indicates the differential value BV occurring when the object-to-be-measured 1 is swung to determine whether the swing data SwD is to be deleted. If it is determined that the swing data SwD does not indicate the differential value BV occurring when the object-to-be-measured 1 is swung, the arithmetic circuit 30 performs the deleting step of deleting the swing data SwD. A data processing apparatus that does not perform the acquiring step, the determining step, and the deleting step (hereinafter referred to as a first comparative example) is compared with the data processing apparatus 2 for description.

In the first comparative example, the swing data may be transmitted to the storage medium regardless of whether the swing data SwD is to be deleted. For example, the swing data that is acquired when the user pushes down the object to be measured or the like may be transmitted to the storage medium. Thus, the capacity of the storage medium is likely to be squeezed.

In contrast, the data processing apparatus 2 determines whether the swing data SwD indicates the differential value BV occurring when the object-to-be-measured 1 is swung in the determining step. If it is determined that the swing data SwD does not indicate the differential value BV occurring when the object-to-be-measured 1 is swung, the arithmetic circuit 30 deletes the swing data SwD. In this case, for example, the arithmetic circuit 30 does not transmit, for example, the swing data SwDN illustrated in FIG. 6 to the storage medium 50. Accordingly, the capacity of the storage medium 50 is not squeezed due to the swing data SwDN or the like. As a result, with the data processing apparatus 2, the capacity of the storage medium 50 is less likely to be squeezed.

With the data processing apparatus 2, the data processing apparatus 2 is capable of preventing no-storage of the necessary swing data SwD in the storage medium 50. More specifically, when it is determined that the swing data SwD indicates the differential value BV occurring when the object-to-be-measured 1 is swung, the arithmetic circuit 30 performs the transmitting step of transmitting the swing data SwD to the storage medium 50. A data processing apparatus that does not perform the transmitting step (hereinafter referred to as a second comparative example) is compared with the data processing apparatus 2 for description. In the second comparative example, for example, after the swing data is acquired, there is a probability that the swing data is not transmitted to the storage medium due to an erroneous operation or the like by the user. In this case, the necessary swing data is likely not to be stored in the storage medium. In contrast, in the case of the data processing apparatus 2, the arithmetic circuit 30 transmits the swing data SwD determined not to be deleted in the determining step to the storage medium 50. Accordingly, the data processing apparatus 2 is capable of storing the swing data SwD in the storage medium 50 regardless of the operation by the user. As a result, the data processing apparatus 2 is capable of preventing no-storage of the necessary swing data SwD in the storage medium 50.

The data processing apparatus 2 is capable of more accurately determining whether the swing data SwD is to be deleted. More specifically, the swing data SwD includes the differential value BV (the numerical value corresponding to the physical quantity). The absolute value of the difference between the reference value Siv and the differential value BV is defined as the first difference value DV1. The arithmetic circuit 30 determines that the swing data SwD is not to be deleted if the first difference value DV1 is higher than or equal to the first determination value 1stTh. In this case, the first determination value 1stTh is set based on the magnitude of the first difference value DV1 that is acquired when the object-to-be-measured 1 is swung. The amount of deformation of the object-to-be-measured 1 when the object-to-be-measured 1 is deformed due to an operation other than the swing is smaller than the amount of deformation of the object-to-be-measured 1 when the user swings the object-to-be-measured 1. Accordingly, if the value of the first difference value DV1 in the swing data SwD is lower than the first determination value 1stTh, the swing data SwD is probably the data that is acquired in an operation other than the swing. In this case, the arithmetic circuit 30 determines that the swing data SwD is to be deleted. Accordingly, the data processing apparatus 2 is capable of more accurately determining whether the swing data SwD is to be deleted.

### Second Embodiment

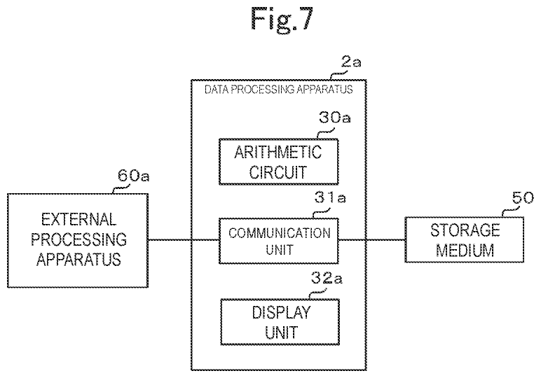

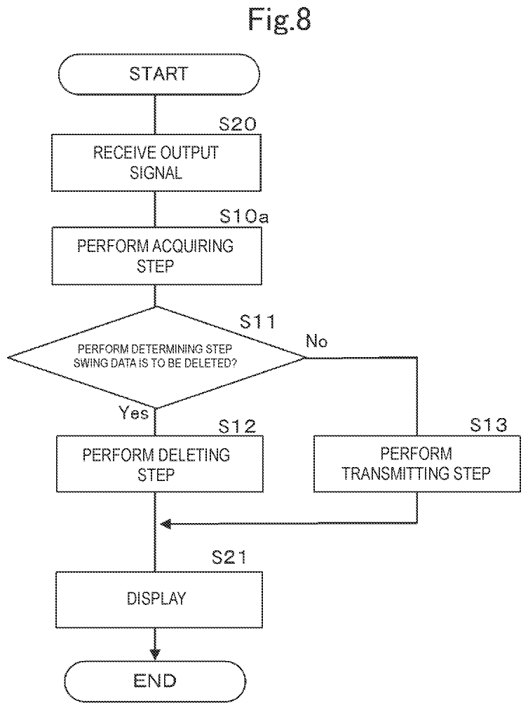

A data processing apparatus 2a according to a second embodiment will herein be described with reference to the drawings. FIG. 7 is a block diagram illustrating one example of the configuration of the data processing apparatus 2a. FIG. 8 is a flowchart indicating a process performed by the data processing apparatus 2a. The data processing apparatus 2a differs from the data processing apparatus 2 in the method of acquiring the swing data SwD. A detailed description will follow. The same reference numerals and letters are used in the data processing apparatus 2a to identify the same components as in the data processing apparatus 2 and a description of such components is omitted herein.

In the second embodiment, the data processing apparatus 2a is connected to an external processing apparatus 60a so as to be capable of communication. The external processing apparatus 60a is an apparatus different from the data processing apparatus 2a. Specifically, the external processing apparatus 60a is an apparatus including the sensor 10 in the first embodiment and a radio communication device (not illustrated). In the present embodiment, the data processing apparatus 2a performs the acquiring step, the determining step, and the deleting step. The data processing apparatus 2a is, for example, a smartphone, a personal computer (PC), or the like. For example, the smartphone, the PC, or the like includes the ROM and the RAM. The ROM stores an application program performing the acquiring step, the determining step, and the deleting step. The smartphone, the PC, or the like reads out, for example, the application program stored in the ROM into the RAM to perform the acquiring step, the determining step, and the deleting step.

A detailed description will follow. As illustrated in FIG. 7, the data processing apparatus 2a includes an arithmetic circuit 30a, a communication unit 31a (e.g., a receiver), and a display unit 32a. The data processing apparatus 2a is connected to the external processing apparatus 60a different from the data processing apparatus 2a via the communication unit 31a so as to be capable of communication. The communication unit 31a receives the output signal Sig1 corresponding to the differential value BV (the physical quantity concerning the amount of deformation of the object-to-be-measured 1) from the external processing apparatus 60a. Specifically, the external processing apparatus 60a generates the output signal Sig1 corresponding to the physical quantity. The external processing apparatus 60a generates the output signal Sig1, for example, in the same manner as in the sensor 10 according to the first embodiment. The communication unit 31a receives the output signal Sig1 from the external processing apparatus 60a. The arithmetic circuit 30a receives the output signal Sig1 from the communication unit 31a. The arithmetic circuit 30a generates the swing data SwD based on the output signal Sig1 to acquire the swing data SwD.

The order of the steps in the process in the data processing apparatus 2a will now be described. First, the communication unit 31a receives the output signal Sig1 corresponding to the physical quantity from the external processing apparatus 60a different from the data processing apparatus 2a (Step S20 in FIG. 8).

Next, the arithmetic circuit 30a generates the swing data SwD based on the output signal Sig1 to acquire the swing data SwD in the acquiring step (Step S10a in FIG. 8). For example, the output signal Sig1 outputted from the external processing apparatus 60a from the time ST to the time ED is inputted into the arithmetic circuit 30a in the same manner as in the data processing apparatus 2. The arithmetic circuit 30a acquires the swing data SwD indicating the relationship between the differential value BV and the time t from the time ST to the time ED in the above manner.

After generating the swing data SwD, the arithmetic circuit 30a performs the determining step (Step S11 in FIG. 8).

If the arithmetic circuit 30a determines that the swing data SwD is to be deleted (Yes in Step S11 in FIG. 8), the arithmetic circuit 30a performs the deleting step (Step S12 in FIG. 8).

If the arithmetic circuit 30a determines that the swing data SwD is not to be deleted (No in Step S11 in FIG. 8), the arithmetic circuit 30a performs the transmitting step (Step S13 in FIG. 8). In this case, as illustrated in FIG. 7, the data processing apparatus 2a transmits the swing data SwD to the storage medium 50 via the communication unit 31a. In this case, a server (not illustrated) or the like includes the storage medium 50.

A process in the display unit 32a in the data processing apparatus 2a according to the second embodiment will now be described. The display unit 32a performs display based on the result of the deleting step. The display unit 32a displays, for example, a result indicating whether the swing data SwD has been deleted. For example, if the arithmetic circuit 30a has performed the deleting step, the display unit 32a displays a text message, for example, “the swing data SwD has been deleted”. If the arithmetic circuit 30a has performed the transmitting step, the display unit 32a displays a text message, for example, “the swing data SwD has been stored”.

### (Effects of Data Processing Apparatus 2a)

With the data processing apparatus 2a, the capacity of the storage medium 50 is less likely to be squeezed. More specifically, the data processing apparatus 2a includes the communication unit 31a. The communication unit 31a receives the output signal Sig1 corresponding to the physical quantity from the external processing apparatus 60a different from the data processing apparatus 2a. The arithmetic circuit 30a generates the swing data SwD based on the output signal Sig1 to acquire the swing data SwD in the acquiring step. After generating the swing data SwD, the arithmetic circuit 30a performs the determining step. In this case, with the data processing apparatus 2a, the capacity of the storage medium 50 is less likely to be squeezed for the same reason as in the data processing apparatus 2.

With the data processing apparatus 2a, it is possible to provide the user-friendly data processing apparatus 2a. More specifically, the data processing apparatus 2a includes the display unit 32a. The display unit 32a performs display based on the result of the deleting step. When the data processing apparatus 2a does not include the display unit 32a, the user is not notified whether the swing data SwD has been deleted. Accordingly, the user does not know whether the swing data SwD has been deleted. As a result, the user may be confused. However, when the data processing apparatus 2a includes the display unit 32a, the display unit 32a notifies the user whether the swing data SwD has been deleted. Accordingly, the user knows whether the swing data SwD has been deleted. As a result, the probability of the user's confusion is reduced. In other words, it is possible to provide the user-friendly data processing apparatus 2a.

### Third Embodiment

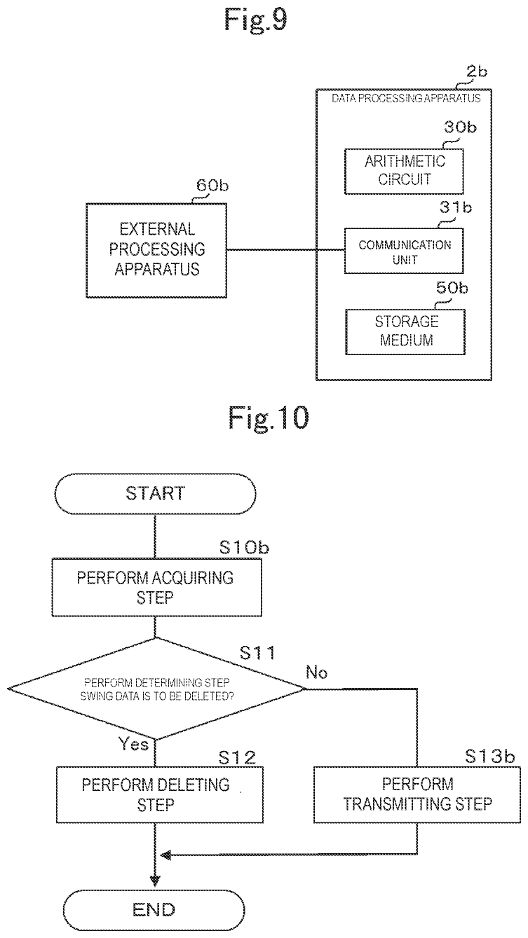

A data processing apparatus 2b according to a third embodiment will herein be described with reference to the drawings. FIG. 9 is a block diagram illustrating one example of the configuration of the data processing apparatus 2b. FIG. 10 is a flowchart indicating a process performed by the data processing apparatus 2b. The data processing apparatus 2b differs from the data processing apparatus 2 in the method of acquiring the swing data SwD. A detailed description will follow. The same reference numerals and letters are used in the data processing apparatus 2b to identify the same components as in the data processing apparatus 2 and a description of such components is omitted herein.

In the third embodiment, the data processing apparatus 2b is connected to an external processing apparatus 60b so as to be capable of communication. The external processing apparatus 60b is an apparatus different from the data processing apparatus 2a. Specifically, the external processing apparatus 60b is, for example, a smartphone, a PC, or the like. The data processing apparatus 2b is, for example, a server or the like. In the present embodiment, the data processing apparatus 2b performs the acquiring step, the determining step, and the deleting step. A detailed description will follow.

As illustrated in FIG. 9, the data processing apparatus 2b includes an arithmetic circuit 30b, a communication unit 31b, and a storage medium 50b. The data processing apparatus 2b is connected to the external processing apparatus 60b different from the data processing apparatus 2b via the communication unit 31b. The communication unit 31b receives the swing data SwD from the external processing apparatus 60b. Specifically, the external processing apparatus 60b generates the swing data SwD, for example, in the same manner as in the data processing apparatus 2a according to the second embodiment. The communication unit 31b receives the generated swing data SwD. In other words, in the present embodiment, the communication unit 31b receives the swing data SwD from the external processing apparatus 60b different from the data processing apparatus 2b to acquire the swing data SwD.

The order of the steps in the process in the data processing apparatus 2b will now be described. First, the communication unit 31b receives the swing data SwD from the external processing apparatus 60b different from the data processing apparatus 2b to acquire the swing data SwD in the acquiring step (Step S10b in FIG. 10).

After the swing data SwD is received, the arithmetic circuit 30b performs the determining step (Step S11 in FIG. 10).

If the arithmetic circuit 30b determines that the swing data SwD is to be deleted (Yes in Step S11 in FIG. 10), the arithmetic circuit 30b performs the deleting step (Step S12 in FIG. 10).

If the arithmetic circuit 30b determines that the swing data SwD is not to be deleted (No in Step S11 in FIG. 10), the arithmetic circuit 30b further performs the transmitting step of transmitting the swing data SwD to the storage medium 50b (Step S13b in FIG. 10).

### (Effects of Data Processing Apparatus 2b)

With the data processing apparatus 2b, the capacity of the storage medium 50b is less likely to be squeezed. More specifically, the data processing apparatus 2b includes the communication unit 31b. The communication unit 31b receives the swing data SwD from the external processing apparatus 60b different from the data processing apparatus 2b to acquire the swing data SwD in the acquiring step. After the swing data SwD is received, the arithmetic circuit 30b performs the determining step. In this case, with the data processing apparatus 2b, the capacity of the storage medium 50b is less likely to be squeezed for the same reason as in the data processing apparatus 2.

With the data processing apparatus 2b, the data processing apparatus 2b is capable of preventing no-storage of the necessary swing data SwD in the storage medium 50b. More specifically, the data processing apparatus 2b includes the storage medium 50b. If the arithmetic circuit 30b determines that the swing data SwD is not to be deleted, the arithmetic circuit 30b performs the transmitting step of transmitting the swing data SwD to the storage medium 50b. In this case, the data processing apparatus 2b is capable of preventing no-storage of the necessary swing data SwD in the storage medium 50b for the same reason as in the data processing apparatus 2.

### (First Modification of Determination Method in Determining Step)

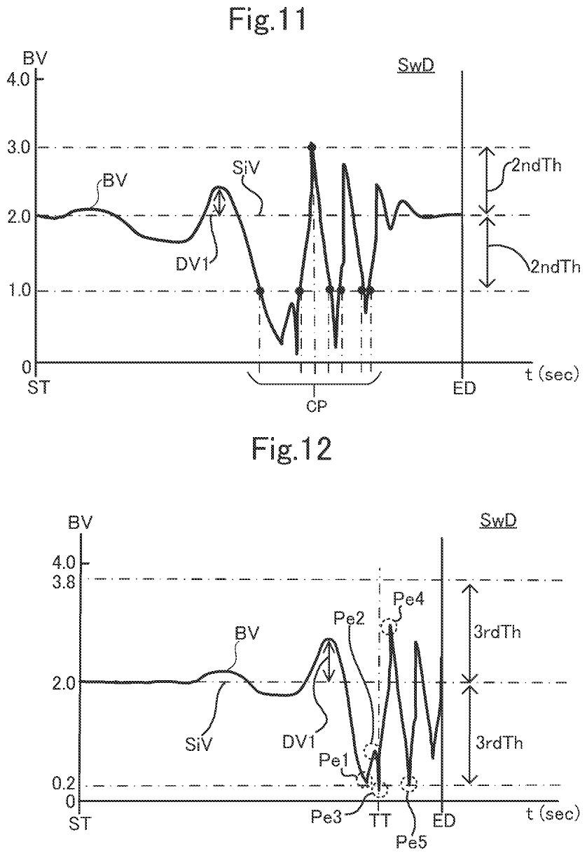

A first modification of the determination method in the determining step will now be described with reference to the drawing. FIG. 11 is a graph indicating the first modification of the determination method in the determining step. A data processing apparatus 2c (not illustrated) according to the first modification includes an arithmetic circuit 30c (not illustrated). The structure of the data processing apparatus 2c is described through incorporation by reference of FIG. 2. The arithmetic circuit 30c detects the number of times when the first difference value DV1 exceeds a second determination value 2ndTh to determine whether the swing data SwD is to be deleted in the determining step. In this case, the data processing apparatus 2c stores the second determination value 2ndTh. For example, as illustrated in FIG. 11, the data processing apparatus 2c stores the second determination value 2ndTh=1.0.

A process in the arithmetic circuit 30c will now be described. The arithmetic circuit 30c acquires the swing data SwD. The swing data SwD includes a numerical value corresponding to the physical quantity. In the present modification, the swing data SwD includes the differential value BV (refer to FIG. 11). Here, the absolute value of the difference between the reference value Siv and the differential value BV (the numerical value corresponding to the physical quantity) is defined as the first difference value DV1. The arithmetic circuit 30c performs a counting step of counting the number of times when the first difference value DV1 is higher than or equal to the second determination value 2ndTh. For example, in the example illustrated in FIG. 11, the number of times when the first difference value DV1 is higher than or equal to the second determination value 2ndTh is seven. In this case, the arithmetic circuit 30c counts the number of times when the first difference value DV1 is higher than or equal to the second determination value 2ndTh as seven. If the number of times exceeds a reference number, the arithmetic circuit 30c determines that the swing data SwD is not to be deleted. The reference number is set in the data processing apparatus 2c. For example, in the example illustrated in FIG. 11, the reference number is set to “5” in the data processing apparatus 2c. In this case, the data processing apparatus 2c determines whether the number of times when the first difference value DV1 is higher than or equal to the second determination value 2ndTh is five or more. In the example illustrated in FIG. 11, the number of times when the first difference value DV1 is higher than or equal to the second determination value 2ndTh=“7” is higher than or equal to the reference number=“5”. Accordingly, the arithmetic circuit 30c determines that the swing data SwD is not to be deleted. In contrast, in the example illustrated in FIG. 11, when the reference number is set to “10” in the data processing apparatus 2c, the number of times when the first difference value DV1 is higher than or equal to the second determination value 2ndTh=“7” is lower than the reference number=“10”. Accordingly, the arithmetic circuit 30c determines that the swing data SwD is to be deleted. The data processing apparatus 2c described above is capable of more accurately determining whether the swing data SwD is to be deleted for the same reason as in the data processing apparatus 2.

### (Second Modification of Determination Method in Determining Step)

A second modification of the determination method in the determining step will now be described with reference to the drawing. FIG. 12 is a graph indicating the second modification of the determination method in the determining step. A data processing apparatus 2d (not illustrated) according to the second modification includes an arithmetic circuit 30d (not illustrated). The structure of the data processing apparatus 2d is described through incorporation by reference of FIG. 2. The arithmetic circuit 30d identifies a peak of one or multiple numerical values in the swing data SwD. Then, the arithmetic circuit 30d determines whether the swing data SwD is to be deleted based on the peak of the numerical value. A detailed description will follow.

The arithmetic circuit 30d acquires the swing data SwD. The swing data SwD includes a numerical value corresponding to the physical quantity. In the present modification, the swing data SwD includes the differential value BV (refer to FIG. 12). Here, the absolute value of the difference between the reference value Siv and the differential value BV (the numerical value corresponding to the physical quantity) is defined as the first difference value DV1. The arithmetic circuit 30d identifies a peak Pe of one or multiple numerical values in the swing data SwD if the first difference value DV1 is higher than or equal to a third determination value 3rdTh. For example, in the example illustrated in FIG. 12, the first difference value DV1 is higher than or equal to the third determination value 3rdTh at the time TT. In this case, the arithmetic circuit 30d identifies peaks Pe1, Pe2, Pe3, Pe4, and Pe5 of the numerical values, as illustrated in FIG. 12. Then, the arithmetic circuit 30d performs the determining step based on the differential value BV at the time TT when the first difference value DV1 is higher than or equal to the third determination value 3rdTh and the numerical value at the peak Pe. For example, the arithmetic circuit 30d calculates the absolute value of the difference between the differential value BV and the value of the peak Pe. At this time, for example, if the absolute value of the difference between the differential value BV and the value of the peak Pe is higher than or equal to a fourth determination value (not illustrated), the arithmetic circuit 30d determines that the swing data SwD is to be deleted. The data processing apparatus 2d described above is capable of more accurately determining whether the swing data SwD is to be deleted for the same reason as in the data processing apparatus 2.

### Other Embodiments

The data processing apparatuses 2, 2a, 2b, 2c, and 2d according to the present disclosure are not limited to the data processing apparatuses 2, 2a, 2b, 2c, and 2d and may be modified within the scope of the present disclosure. The configurations of the data processing apparatuses 2, 2a, 2b, 2c, and 2d may be arbitrarily combined.

The arithmetic circuits 30, 30a, 30b, 30c, 30d, and 30e may perform the determining step based on machine learning or artificial intelligence. When the machine learning is used, the arithmetic circuits 30, 30a, 30b, 30c, 30d, and 30e learn, for example, the swing data SwD that is acquired when the object-to-be-measured 1 is swung as training data. Accordingly, the arithmetic circuits 30, 30a, 30b, 30c, 30d, and 30e are capable of determining whether the swing data SwD is to be deleted, for example, through pattern recognition based on the training data. When the artificial intelligence is used, the data processing apparatuses 2, 2a, and 2b store a learned model indicating the relationship between a feature value included in the swing data SwD and a user's operation when the swing data SwD is acquired. The arithmetic circuits 30, 30a, 30b, 30c, 30d, and 30e input the swing data SwD in the learned model. The learned model outputs a result indicating whether the swing data SwD is to be deleted. At this time, the arithmetic circuits 30, 30a, 30b, 30c, 30d, and 30e perform modification or the like of the learned model based on the output result. The arithmetic circuits 30, 30a, 30b, 30c, 30d, and 30e are capable of improving the accuracy of the determination of whether the data is to be deleted in the arithmetic circuits 30, 30a, 30b, 30c, 30d, and 30e in the above manner.

The object-to-be-measured 1 is not necessarily a golf club. The object-to-be-measured 1 may be a rod-shaped member, such as a baseball bat or a tennis racket, a badminton racket, or the like. In other words, the object-to-be-measured 1 may include at least one of the golf club, the bat, and the racket. The bat and the racket are the objects-to-be-measured 1 that are likely to be deformed during the swing, like the golf club. In other words, when the object-to-be-measured 1 is the bat or the racket, the data processing apparatuses 2, 2a, 2b, 2c, and 2d easily detect the deformation of the object-to-be-measured 1 when the user swings the object-to-be-measured 1.

In the first embodiment, the data processing apparatus 2 performs the determining step based on the first difference value DV1. The first difference value DV1 is the absolute value of the difference from the numerical value corresponding to the physical quantity. In other words, the data processing apparatus 2 is capable of performing the determining step even when the waveform of the output signal Sig1 is reversed with respect to the reference value Siv. Accordingly, the data processing apparatus 2 is capable of determining whether the swing data SwD is to be deleted even when the user reverses the object-to-be-measured 1 each time the user swings the object-to-be-measured 1. For example, when the object-to-be-measured 1 is the bat, the racket, or the like, the user may reverse the object-to-be-measured 1 each time the user swings the object-to-be-measured 1. Also in this case, the data processing apparatus 2 is capable of accurately determining whether the swing data SwD is to be deleted in each swing. Similarly, the data processing apparatus 2 is capable of accurately determining whether the swing data SwD is to be deleted even when the user changes the direction in which the object-to-be-measured 1 is swung each time the user swings the object-to-be-measured 1.

In the first embodiment, the object-to-be-measured 1 is a golf club. However, the swing data SwD is not necessarily the swing data that is acquired when the golf club hits the golf ball. In other words, the data processing apparatuses 2, 2a, 2b, 2c, and 2d are capable of being used in both the case in which the object-to-be-measured 1 has hit an object to be hit and the case in which the object-to-be-measured 1 has not hit an object to be hit. Accordingly, also when the object-to-be-measured 1 is a game controller or the like, the data processing apparatuses 2, 2a, 2b, 2c, and 2d are capable of being used for the determination of whether the data is to be deleted.

The data processing apparatus 2 does not necessarily include the AD converter 20. In other words, the data processing apparatus 2 does not necessarily receive the signal subjected to the AD conversion in the AD converter 20.

The direction of deformation of the object-to-be-measured 1 is not limited to the vertical direction. For example, the object-to-be-measured 1 may be deformed in the rotation direction around the center of the object-to-be-measured 1 when viewed in the vertical direction. In other words, the object-to-be-measured 1 may be twisted in the rotation direction. In this case, the sensor 10 may detect the twist in the rotation direction.

The physical quantity may include something other than the amount of deformation of the object-to-be-measured 1, the differential value of the amount of deformation of the object-to-be-measured 1, and the stress occurring at the object-to-be-measured 1.

The sensor 10 may be a strain gauge. In this case, the physical quantity measured by the sensor 10 is the amount of deformation of the object-to-be-measured 1. In other words, in the first embodiment, the physical quantity is not necessarily the differential value BV of the amount of deformation of the object-to-be-measured 1.

The arithmetic circuit 30 may perform the determining step based on the differential value of the amount of deformation in the vertical direction of the piezoelectric film 100. In this case, the physical quantity includes the differential value of the amount of deformation in the vertical direction of the piezoelectric film 100.

The first determination value 1stTh is not necessarily set to “1.8”.

The reference value Siv is not necessarily set to “2.0”.

The second determination value 2ndTh is not necessarily set to “1.0”.

In the first modification, the reference number may have a value other than “5” or “10”.

The arithmetic circuits 30, 30a, 30b, 30c, 30d, and 30e are not necessarily the CPUs. The arithmetic circuits 30, 30a, 30b, 30c, 30d, and 30e may be, for example, micro processing units (MPUs) or the likes.

The memory 40 does not necessarily include the ROM. The memory 40 may include, for example, a flash memory, instead of the ROM.

The data processing apparatus 2 does not necessarily include the AD converter 20.

In the first embodiment, the AD converter 20 and the arithmetic circuit 30 are not necessarily mounted on the object-to-be-measured 1 as long as the sensor 10 is connected to the arithmetic circuit 30 so as to be capable of communication.

In the first embodiment, the arithmetic circuit 30 acquires the swing data SwD, for example, using the following method. The data processing apparatus 2 has a button (hereinafter referred to as a button X) (not illustrated). When the button X is depressed by the user, the arithmetic circuit 30 starts to receive the output signal Sig1 from the sensor 10. For example, as illustrated in FIG. 4, the user depresses the button X at the time ST. In this case, the arithmetic circuit 30 starts to receive the output signal Sig1 from the time ST. When the button X is then depressed by the user, the arithmetic circuit 30 terminates the reception of the output signal Sig1. For example, as illustrated in FIG. 4, the user depresses the button X at the time ED. In this case, the arithmetic circuit 30 terminates the reception of the output signal Sig1 at the time ED. As a result, as illustrated in FIG. 4, the arithmetic circuit 30 acquires the output signal Sig1 that has been received from the time ST to the time ED as the swing data SwD. Similarly, the external processing apparatus 60a may acquire the swing data SwD using the button X.

In the first embodiment, the arithmetic circuit 30 may acquire the swing data SwD by setting a trigger. For example, if the first difference value DV1 is higher than or equal to the first determination value 1stTh, the arithmetic circuit 30 may acquire the differential value BV at times before and after the time when the first difference value DV1 has been higher than or equal to the first determination value 1stTh. For example, in the example illustrated in FIG. 4, the arithmetic circuit 30 may acquire the output signal Sig1 during a period between the time five seconds before the time TT and the time five seconds after the time TT as the swing data SwD. Similarly, the external processing apparatus 60a may acquire the swing data SwD by setting a trigger.

The value of the output signal Sig1 does not necessarily coincide with the value of the swing data SwD. For example, the output signal Sig1 may be outputted as a voltage value and the swing data SwD may be outputted as a binary value.

In the first embodiment, it is sufficient for the data processing apparatus 2 to be connected to the storage medium 50 in a wireless manner, such as Bluetooth (registered trademark) or Wi-Fi (registered trademark). The data processing apparatus 2 may be connected to the storage medium 50 in a wired manner.

In the second embodiment, it is sufficient for the communication unit 31a to be connected to the external processing apparatus 60a in a wireless manner, such as Bluetooth (registered trademark) or Wi-Fi (registered trademark). The communication unit 31a may be connected to the external processing apparatus 60a in a wired manner. Similarly, it is sufficient for the communication unit 31a to be connected to the storage medium 50 in a wireless manner or in a wired manner.

In the third embodiment, it is sufficient for the communication unit 31b to be connected to the external processing apparatus 60b in a wireless manner, such as Bluetooth (registered trademark) or Wi-Fi (registered trademark). The communication unit 31b may be connected to the external processing apparatus 60b in a wired manner.

The display unit 32a may indicate whether the deleting step has been performed using a method other than the display of a text message. The display unit 32a may indicate whether the deleting step has been performed, for example, by displaying an image.

The storage media 50 and 50b are, for example, solid state drives (SSDs) or hard disk drives (HDDs).
1 object-to-be-measured
2, 2a, 2b, 2c, 2d data processing apparatus
30, 30a, 30b, 30c, 30d arithmetic circuit
50, 50b storage medium
BV differential value
Sig1 output signal
DV1 first difference value
SwD, SwDN swing data

1. A data processing apparatus comprising:
an arithmetic circuit configured to:
acquire swing data indicating a relationship between time and a physical quantity concerning an amount of deformation of an object, the swing data including a numerical value corresponding to the physical quantity;
determine whether the swing data indicates the object is swung;
count a number of times when a first difference value is greater than or equal to a second determination value, the first difference value being an absolute value of a difference between a reference value and the numerical value;
determine whether the counted number of times exceeds a reference number;
delete the swing data when it is determined that the swing data does not indicate the object is swung; and
not delete the swing data when it is determined that the swing data indicates the object is swung or the counted number of times exceeds the reference number.

2. The data processing apparatus according to claim 1, wherein the arithmetic circuit is further configured to transmit the swing data to a storage medium when it is determined that the swing data indicates the object is swung.

3. The data processing apparatus according to claim 1, further comprising:
a sensor,
wherein the sensor is configured to generate an output signal corresponding to the physical quantity,
wherein the arithmetic circuit is configured to generate the swing data based on the output signal, and
wherein the arithmetic circuit is configured to determine whether the swing data indicates the object is swung and whether the counted number of times exceeds the reference number after generating the swing data.

4. The data processing apparatus according to claim 3, wherein the sensor is mounted to the object.

5. The data processing apparatus according to claim 1, further comprising:
a receiver,
wherein the receiver is configured to receive an output signal corresponding to the physical quantity from an external processing apparatus different from the data processing apparatus,
wherein the arithmetic circuit is configured to acquire the swing data by generating the swing data based on the output signal, and
wherein the arithmetic circuit is configured to determine whether the swing data indicates the object is swung and whether the counted number of times exceeds the reference number after generating the swing data.

6. The data processing apparatus according to claim 5, further comprising:
a display,
wherein the display is configured to display information based on whether swing data is deleted.

7. The data processing apparatus according to claim 1, further comprising:
a receiver,
wherein the receiver is configured to receive the swing data from an external processing apparatus different from the data processing apparatus to acquire the swing data, and
wherein the arithmetic circuit is configured to determine whether the swing data indicates the object is swung and whether the counted number of times exceeds the reference number after the swing data is received.

8. The data processing apparatus according to claim 7, further comprising:
a storage medium,
wherein the arithmetic circuit is configured to transmit the swing data to the storage medium when the arithmetic circuit determines not to delete the swing data.

9. The data processing apparatus according to claim 1, wherein the arithmetic circuit is configured to determine whether the swing data indicates the object is swung or whether the counted number of times exceeds the reference number based on machine learning or artificial intelligence.

10. The data processing apparatus according to claim 1, wherein the object is a golf club, a bat, or a racket.

11. The data processing apparatus according to claim 1,
wherein the arithmetic circuit is further configured to identify a peak of the numerical value or a plurality of numerical values in the swing data when the first difference value is greater than or equal to a third determination value, and
wherein the arithmetic circuit is configured to determine whether the swing data indicates the object is swung or whether the counted number of times exceeds the reference number based on the first difference value at a time when the first difference value is greater than or equal to the third determination value and the numerical value at the peak.

12. A non-transitory computer readable medium having instructions stored thereon that, when executed in an arithmetic circuit in a data processing apparatus, causes the arithmetic circuit to:
acquire swing data indicating relationship between time and a physical quantity concerning an amount of deformation of an object the swing data including a numerical value corresponding to the physical quantity;
determine whether the swing data indicates the object is swung;
count a number of times when a first difference value is greater than or equal to a second determination value, the first difference value being an absolute value of a difference between a reference value and the numerical value;
determine whether the counted number of times exceeds a reference number;
delete the swing data when it is determined that the swing data does not indicate the object is swung; and
not delete the swing data when it is determined that the swing data indicates the object is swung or the counted number of times exceeds the reference number.

13. A method comprising:
acquiring swing data indicating relationship between time and a physical quantity concerning an amount of deformation of an object the swing data including a numerical value corresponding to the physical quantity;
determining whether the swing data indicates the object is swung;
counting a number of times when a first difference value is greater than or equal to a second determination value, the first difference value being an absolute value of a difference between a reference value and the numerical value;
determining whether the counted number of times exceeds a reference number;
deleting the swing data when it is determined that the swing data does not indicate the object is swung; and
not deleting the swing data when it is determined that the swing data indicates the object is swung or the counted number of times exceeds the reference number.
